(19) United States
(12) Patent Application Publication
(10) Pub. No.: US 2007/0069916 A1
(43) Pub. Date: Mar. 29, 2007

(54) METHOD AND APPARATUS FOR PERFORMING AUTOMATIC IDENTITY CODE LEARNING AND IDENTITY CODE VERIFICATION IN A WIRELESS COMMUNICATION SYSTEM

(76) Inventors: Ming-Yu Lin, Tai-Nan City (TW); Jui-Jung HUANG, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/535,493

(22) Filed: Sep. 27, 2006

(30) Foreign Application Priority Data
Sep. 29, 2005 (TW) 094133986

(51) Int. Cl. G05B 19/02; H02J 13/00

(52) U.S. Cl. 340/825.22; 340/825.69; 340/825.52

(57) ABSTRACT

A data processing method of a wireless communication system includes generating an identity code corresponding to a receiver, storing the identity code in a receiver, exclusive-oring output data with the identity code corresponding to the receiver, outputting the exclusive-ored data, receiving data at a receiver, and exclusive-oring the received data with an identity code stored in the receiver. The data processing method performs automatic identity code learning and identity code verification with exclusive-or operations in the wireless communication system.

### BACKGROUND OF THE INVENTION

1. Field of the Invention

The present invention relates to a method and an apparatus in a wireless communication system, and more particularly, to a method and an apparatus for performing automatic identity code learning and identity code verification in a wireless communication system.

2. Description of the Prior Art

With rapid development of technology, more and more electronic devices transmit and receive data using wireless transmission. Such devices include personal digital assistants (PDAs), digital cameras, digital videos, cellular phones, notebooks, and other mobile electronic devices. As Internet connections become more and more common, wireless technology enables wireless communication between mobile electronic devices and the Internet within the effective transmission range of wireless communication.

Please refer to FIG. 1 for a prior art wireless communication system 10. The wireless communication system 10 includes a transmitter 110 and a receiver 120. The transmitter 110 includes a first processor 112, a first memory unit 114, a transmitting circuit 116 and a first dip switch 118. The first processor 112 controls the operations of all devices of the transmitter 110. An identity code corresponding to the transmitter 110 is stored in the first memory unit 114. The transmitter 110 outputs signals using the transmitting circuit 116. The identity code of the transmitter 110 can be adjusted by adjusting the first dip switch 118. The receiver 120 includes a second processor 122, a second memory unit 124, a receiving circuit 126 and a second dip switch 128. The receiving circuit 126 receives data outputted from the transmitting circuit 116 of the transmitter 110. An identity code corresponding to the receiver 120 is stored in the second memory unit 124. The second processor 122 controls the operations of all devices of the receiver 120. The identity code of the receiver 120 can be adjusted by adjusting the second dip switch 128.

It is necessary to perform steps of identification code verification during wireless transmission. Each type of wireless products has its own transmitter and receiver. In order to prevent a receiver from receiving data from transmitters other than its own corresponding receiver and receiving undesired data, it is required to set the identification codes for the transmitter and its corresponding receiver before wireless data transmission. For example, if the wireless communication system 10 shown in FIG. 1 is a wireless earphone and 8-bit identification codes are used during wireless transmission, the first and second dip switches 118 and 128, each having 8 control bottoms set to either 0 or 1, have to be disposed at the transmitter 110 and the receiver 120, respectively. Before wireless data transmission, a user has to manually adjust the first and second dip switches 118 and 128, so that the transmitter 110 and the receiver 120 can have the same identity code for subsequent wireless data transmission. The manual adjustment is very inconvenient for users since it includes adjusting each control bottom of the dip switches separately. In addition, each wireless device requires two dip switches for its transmitter and its receiver. The dip switches not only increase manufacturing cost, but also increase the sizes of the transmitter and the receiver. If the user purchases a new transmitter for replacing a malfunctioning transmitter, the identity codes of the new transmitter together with the original receiver have to be reset again. Therefore, it is very time and effort consuming.

Please refer to FIG. 2 for a diagram of a data packet 20 generated by the wireless communication system 10 during wireless transmission. The data packet 20 includes an identity code 22, data 24 and a cyclic redundancy check (CRC) 26. The identity code 22 of the data packet 20 used for performing identity code verification includes fixed and limited width. For example, the identity code 22 in FIG. 2 includes 8 bits which can provide 256 (2⁸) different identity codes. This amount of identity codes is far from enough since the product quantity of the wireless devices easily exceeds 256. Therefore, it is very easy for different products to possess the same identity code in prior art wireless communication systems.

The dip switches of the prior art wireless communication system not only increase manufacturing cost, but also increase the sizes of the transmitter and the receiver. If a transmitter of a device malfunctions, a new transmitter for replacing the malfunctioning transmitter has to be reset again together with the original receiver. The procedure is time and effort consuming, and is thus very inconvenient for users. Also, the prior art wireless communication can only provide a fixed and limited number of identity codes. Thus the identity codes of different devices are easily repeated in the prior art wireless communication system.

### SUMMARY OF THE INVENTION

It is therefore a primary objective of the present invention to provide a method and an apparatus for performing automatic identity code learning and identity code verification in a wireless communication system in order to solve the problems of the prior art.

The claimed invention provides a wireless communication system capable of performing automatic identity code learning and identity code verification, the wireless communication system comprising a transmitter and a receiver. The transmitter comprises a first processor for controlling operations of the transmitter, a first memory unit for storing an identity code corresponding to the transmitter, a first logic circuit coupled to the first memory unit and the first processor for executing an exclusive-or operation on an output signal of the transmitter and the identity code of the transmitter, and a transmitting circuit for outputting data generated after the exclusive-or operation executed by the first logic circuit. The receiver comprises a receiving circuit for receiving data outputted by the transmitting circuit, a second memory unit for storing the identity code corresponding to the transmitter, a second logic circuit coupled to the second memory unit and the receiving circuit for executing an exclusive-or operation on data received by the receiving circuit and the identity code of the transmitter, and a second processor coupled to the second logic circuit for controlling operations of the receiver.

The claimed invention further provides a transmitter of a wireless communication system capable of performing automatic identity code learning and identity code verification, the transmitter comprising a processor for controlling operations of the transmitter, a memory unit for storing an identity code corresponding to the transmitter, a logic circuit coupled to the memory unit and the processor for executing an exclusive-or operation on an output signal of the transmitter and the identity code of the transmitter, and a transmitting circuit for outputting data generated after the exclusive-or operation executed by the logic circuit.

The claimed invention further provides a receiver of a wireless communication system capable of performing automatic identity code learning and identity code verification, the receiver comprising a receiving circuit for receiving data outputted by a transmitter, a memory unit for storing an identity code corresponding to the transmitter, a logic circuit coupled to the memory unit and the receiving circuit for executing an exclusive-or operation on data received by the receiving circuit and the identity code of the transmitter, and a processor coupled to the second logic circuit for controlling operations of the receiver.

The claimed invention provides a data processing method capable of performing automatic identity code learning and identity code verification using exclusive-or operations, the method comprising: (a) generating an identity code corresponding to a transmitter; (b) storing the identity code generated in (a) in a receiver; (c) exclusive-oring output data of the transmitter with the identity code corresponding to the receiver; and (d) outputting data generated in (c).

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a prior art wireless communication system.

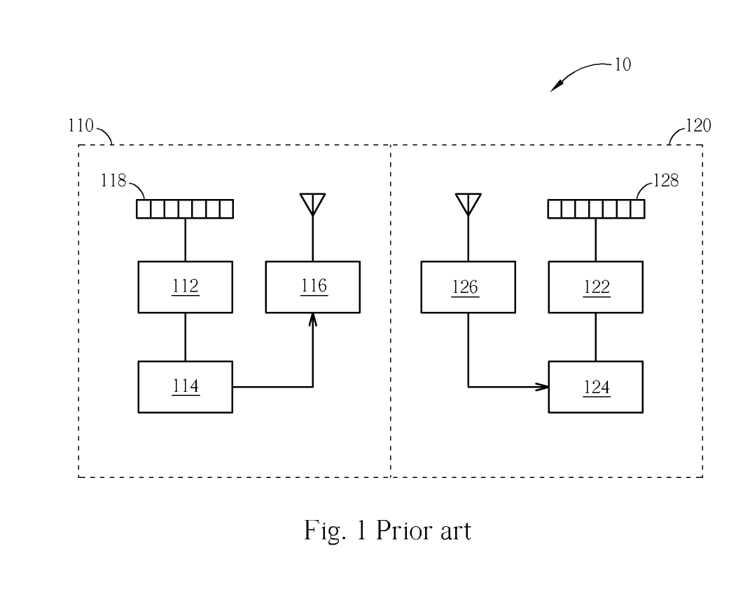

FIG. 2 is a diagram of a data packet generated by the wireless communication system of FIG. 1 during wireless transmission.

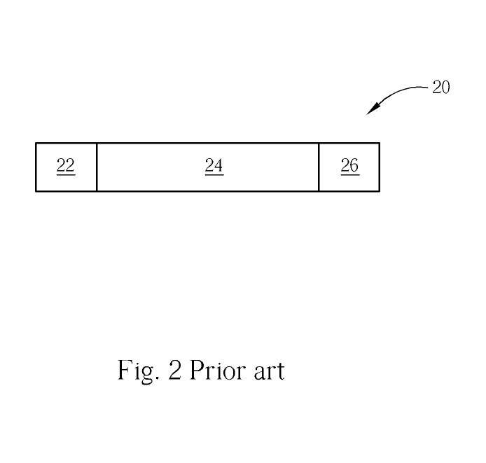

FIG. 3 is a diagram of a wireless communication system according to the present invention.

FIG. 4 is a diagram of a data packet generated by the wireless communication system of FIG. 3 during wireless transmission.

FIG. 5 is a flow chart illustrating steps of performing identity code learning in the wireless communication system of FIG. 3.

FIG. 6 is a flow chart illustrating steps of performing identity code verification in the wireless communication system of FIG. 3.

### DETAILED DESCRIPTION

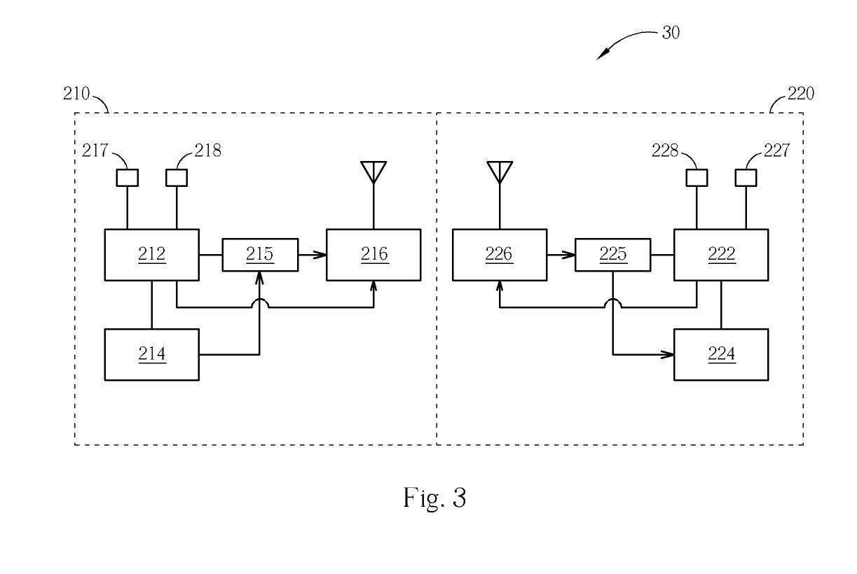

Please refer to FIG. 3 for a wireless communication system 30 according to the present invention. The wireless communication system 30 includes a transmitter 210 and a receiver 220. The transmitter 210 includes a first processor 212, a first memory unit 214, a first logic circuit 215, a transmitting circuit 216, a first indicator 217, and a first identity learning key 218. The first processor 212 controls the operations of all devices of the transmitter 210. An identity code corresponding to the transmitter 210 is stored in the first memory unit 214. The first logic circuit 215 is coupled to the first memory unit 214 and the first processor 212 for exclusive-oring output data of the transmitter 210 with the identity code of the transmitter 210. The transmitter 210 outputs signals using the transmitting circuit 216. The first indicator 217 indicates whether the transmitter 210 and the receiver 220 can synchronize. After the power is turned on, a user can activate steps of identification code learning of the transmitter 210 by pressing the first identity learning key 218.

The receiver 220 includes a second processor 222, a second memory unit 224, a second logic circuit 225, a receiving circuit 226, a second indicator 227, and a second identity learning key 228. The receiving circuit 226 receives data outputted from the transmitting circuit 216 of the transmitter 210. An identity code corresponding to the transmitter 210 is stored in the second memory unit 224. The second logic circuit 225 is coupled to the second memory unit 224 and the second processor 222 for exclusive-oring output data received by the receiving circuit 226 with the identity code of the transmitter 210. The second indicator 227 indicates whether the transmitter 210 and the receiver 220 can synchronize. After the power is turned on, a user can activate steps of identification code learning of the receiver 220 by pressing the second identity learning key 228. The second processor 222 controls the operations of all devices of the receiver 220. When the receiver 220 is about to perform identity code learning, the second processor 222 switches the receiver 220 to a predetermined channel for performing identity code learning.

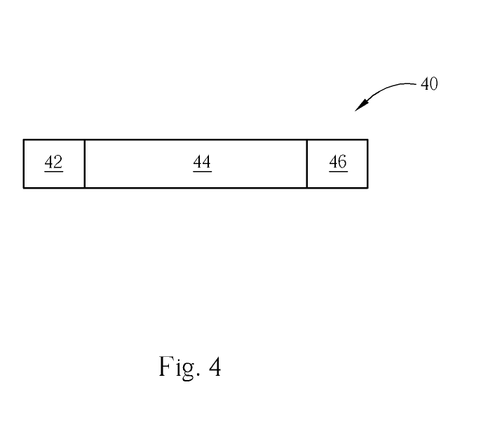

In the present invention, the wireless communication system 30 can have a multi-bit identity code, for example, a 72-bit identity code. When the power of the transmitter 210 and the receiver 220 is turned on, an user can activate the identity code learning procedures of the transmitter 210 and the receiver 220 simply by pressing the first identity learning key 218 and the second identity learning key 228. When performing identity code learning, the transmitter 210 sends its identity code to the receiver 220. The receiver 210 receives and stores the identity code of the transmitter 210. Please refer to FIG. 4 for a diagram of a data packet 40 generated by the transmitter 210 of the wireless communication system 30 during wireless transmission according to the present invention. The data packet 40 includes a header 42, an identity code 44, and a cyclic redundancy check (CRC) 46. The header 42 and the CRC 46 can be used to determine whether the transmitter 210 and the receiver 220 can synchronize. The data length of the identity code 44 can be chosen based on data transmitted by the wireless communication system 30. For example, if a transmitter of a wireless earphone transfers data packets each having 72-bit audio data, the identity 44 can also have 72 bits.

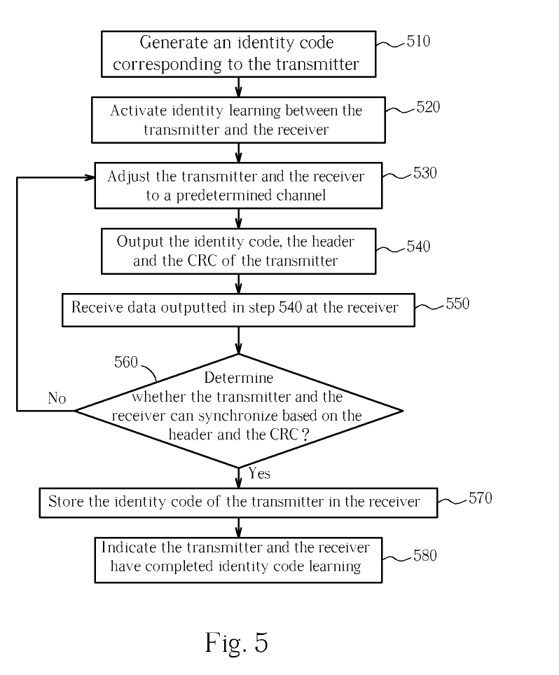

Please refer to FIG. 5 for a flow chart illustrating steps of performing identity code learning in the wireless communication system 30 according to the present invention. FIG. 5 includes the following steps:

step 510: generate an identity code 44 corresponding to the transmitter 210;

step 520: activate identity learning between the transmitter 210 and the receiver 220 by pressing the first identity learning key 218 and the second identity learning key 228;

step 530: adjust the transmitter 210 and the receiver 220 to a predetermined channel;

step 540: output the identity code 44, the header 42 and the CRC 46 of the transmitter 210;

step 550: receive data outputted in step 540 at the receiver 220;

step 560: determine whether the transmitter 210 and the receiver 220 can synchronize based on the header 42 and the CRC 46; if the transmitter 210 and the receiver 220 can synchronize, execute step 570; if the transmitter 210 and the receiver 220 cannot synchronize, execute step 530;

step 570: store the identity code 44 of the transmitter 210 in the receiver 220; and

step 580: indicate the transmitter 210 and the receiver 220 have completed identity code learning using indicators 217 and 227.

In the flow chart of FIG. 5, an undisable identity code 44 is generated for the transmitter 210 in step 510. After adjusting the transmitter 210 and the receiver 220 to the predetermined channel in step 530, the identity code 44, the header 42 and the CRC 46 of the transmitter 210 are outputted in step 540. After receiving data outputted in step 550, it is determined in step 560 whether the transmitter 210 and the receiver 220 can synchronize based on the header 42 and the CRC 46. If one of the header 42 and the CRC 46 is incorrect, the transmitter 210 and the receiver 220 cannot synchronize. In such case, the wireless communication system 30 executes step 530 again and adjusts the transmitter 210 and the receiver 220 to another predetermined channel. After the transmitter 210 and the receiver 220 can synchronize, the wireless communication system 30 then continues on with subsequent steps. When it is determined in step 550 that the transmitter 210 and the receiver 220 can synchronize, the identity code 44 of the transmitter 210 is stored in the receiver 220. Finally, the user is informed of the completion of identity code learning using indicators 217 and 227 in step 580.

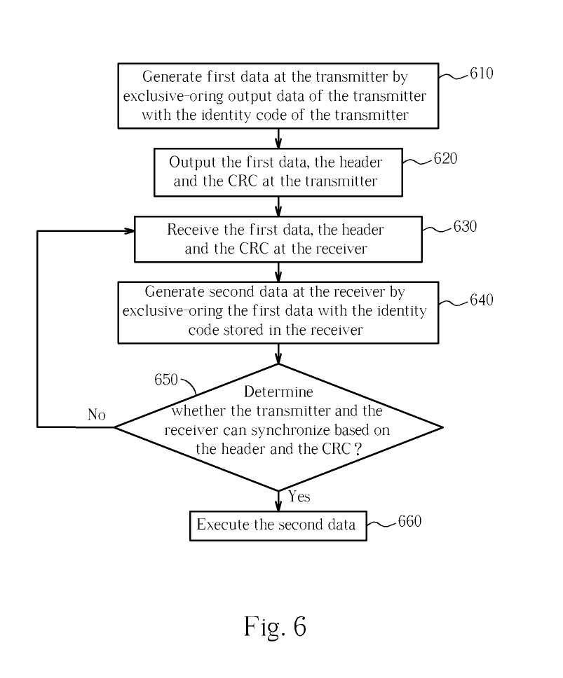

After finishing the steps of identity code learning shown in FIG. 5, the wireless communication system 30 continues to perform steps of identification code verification. First, before outputting data, the transmitter 210 exclusive-ors original output data with the identity code of the transmitter 210. And after receiving data from the transmitter 210, the receiver 220 exclusive-ors the received data with the identity code of the transmitter 210 stored in the receiver 220 for obtaining the original data. Please refer to FIG. 6 for a flow chart illustrating the steps of performing identity code verification in the wireless communication system 30 according to the present invention. FIG. 6 includes the following steps:

step 610: generate first data at the transmitter 210 by exclusive-oring output data of the transmitter 210 with the identity code of the transmitter 210;

step 620: output the first data, the header 42 and the CRC 46 at the transmitter 210;

step 630: receive the first data, the header 42 and the CRC 46 at the receiver 220;

step 640: generate second data at the receiver 220 by exclusive-oring the first data with the identity code 44 stored in the receiver 220;

step 650: determine whether the transmitter 210 and the receiver 220 can synchronize based on the header 42 and the CRC 46; if the transmitter 210 and the receiver 220 can synchronize, execute step 660; if the transmitter 210 and the receiver 220 cannot synchronize, execute step 630; and

step 660: execute the second data.

Before outputting signals, the transmitter 210 of the wireless communication system 30 performs an exclusive-or operation on the original output data and the identity code 44 of the transmitter 210 using the logic circuit 215, and thereby obtains the first data corresponding to the original output data of the transmitter 210 and the identity code 44 of the transmitter 210. In step 620, the transmitter 210 outputs the first data, the header 42 and the CRC 46 using the transmitting circuit 216. In steps 630 and 640, the receiver 220 receives data sent by the transmitter 210 in step 630 and then generates the second data by exclusive-oring the first data with the identity code 44 stored in the receiver 220. Then in step 650, the second processor 222 determines whether the transmitter 210 and the receiver 220 can synchronize. If one of the header 42 and the CRC 46 is incorrect, the transmitter 210 and the receiver 220 cannot synchronize and the wireless communication system 30 executes step 630 again. After having confirmed the synchronization of the transmitter 210 and the receiver 220, the wireless communication system 30 executes the second data in step 660. For audio data of a wireless earphone, the wireless communication system 30 plays the second data in step 660.

In the wireless communication system 30 of the present invention, the first indicator 217 and the second indicator 227 are used to indicate whether the transmitter 210 and the receiver 220 can synchronize. The first indicator 217 and the second indicator 227 can include light emitting diodes (LEDs) or other light emitting devices. When the wireless communication system 30 is in the process of performing identity code learning, the first indicator 217 and the second indicator 227 can be flashing; when the wireless communication system 30 have completed identity code learning, the first indicator 217 and the second indicator 227 can remain radiant.

Compared to the inconvenient dip switches and manual steps of identity code verification in the prior art wireless communication system, the present invention provides methods of performing automatic identity code learning and identity code verification in wireless communication systems. By assigning the multiple-bit identity code 44 for the transmitter 220, the user can activate identity code learning and identity code verification of the transmitter 210 and the receiver 220 simply by pressing the first identity code learning key 218 and the second identity code learning key 218. Then the transmitter 210 and the receiver 220 automatically perform identity code verification based on multiple verifications of the identity code, the header and the CRC. Therefore, the wireless communication systems based on the present invention are more convenient for users. In addition, the present invention can provide more identity codes flexibly and can reduce the possibility of repeated identity codes of different devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication system capable of performing automatic identity code learning and identity code verification comprising:
a transmitter comprising:
a first processor for controlling operations of the transmitter;
a first memory unit for storing an identity code corresponding to the transmitter;
a first logic circuit coupled to the first memory unit and the first processor for executing an exclusive-or operation on an output signal of the transmitter and the identity code of the transmitter; and
a transmitting circuit for outputting data generated after the exclusive-or operation executed by the first logic circuit; and
a receiver comprising:
a receiving circuit for receiving data outputted by the transmitting circuit;
a second memory unit for storing the identity code corresponding to the transmitter;
a second logic circuit coupled to the second memory unit and the receiving circuit for executing an exclusive-or operation on data received by the receiving circuit and the identity code of the transmitter; and
a second processor coupled to the second logic circuit for controlling operations of the receiver.

2. The wireless communication system of claim 1 wherein the first and second memory units each include non-volatile memory.

3. The wireless communication system of claim 1 wherein the first and second processors each include a base band system-on-chip processor.

4. The wireless communication system of claim 1 wherein the transmitting and receivers each include an indicator for indicating whether the transmitter and the receiver can synchronize.

5. The wireless communication system of claim 4 wherein the indicator is a light emitting diode.

6. A transmitter of a wireless communication system capable of performing automatic identity code learning and identity code verification comprising:
a processor for controlling operations of the transmitter;
a memory unit for storing an identity code corresponding to the transmitter;
a logic circuit coupled to the memory unit and the processor for executing an exclusive-or operation on an output signal of the transmitter and the identity code of the transmitter; and
a transmitting circuit for outputting data generated after the exclusive-or operation executed by the logic circuit.

7. The transmitter of claim 6 wherein the first and second memory units each include non-volatile memory.

8. The transmitter of claim 6 wherein the first and second processors each include a base band system-on-chip processor.

9. The transmitter of claim 6 wherein the transmitting and receivers each include an indicator for indicating whether the transmitter and a receiver can synchronize.

10. The transmitter of claim 9 wherein the indicator is a light emitting diode.

11. A receiver of a wireless communication system capable of performing automatic identity code learning and identity code verification comprising:
a receiving circuit for receiving data outputted by a transmitter;
a memory unit for storing an identity code corresponding to the transmitter;
a logic circuit coupled to the memory unit and the receiving circuit for executing an exclusive-or operation on data received by the receiving circuit and the identity code of the transmitter; and
a processor coupled to the second logic circuit for controlling operations of the receiver.

12. The receiver of claim 11 wherein the first and second memory units each include non-volatile memory.

13. The receiver of claim 11 wherein the first and second processors each include a base band system-on-chip processor.

14. The receiver of claim 111 wherein the transmitting and receivers each include an indicator for indicating whether the transmitter and a receiver can synchronize.

15. The receiver of claim 14 wherein the indicator is a light emitting diode.

16. A data processing method capable of performing automatic identity code learning and identity code verification using exclusive-or operations comprising the following steps:
(a) generating an identity code corresponding to a transmitter;
(b) storing the identity code generated in step (a) in a receiver;
(c) exclusive-oring output data of the transmitter with the identity code corresponding to the receiver; and
(d) outputting data generated in step (c).

17. The data processing method of claim 16 further comprising adjusting the receiver and the transmitter to a first predetermined communication channel.

18. The data processing method of claim 17 further comprising outputting a header, a cyclic redundancy check and the identity code.

19. The data processing method of claim 18 further comprising determining whether the receiver and the transmitter can synchronize at the first predetermined communication channel based on the header and the cyclic redundancy check.

20. The data processing method of claim 19 further comprising:
adjusting the receiver and the transmitter to a second predetermined communication channel when the receiver and the transmitter cannot synchronize at the first predetermined communication channel.

21. The data processing method of claim 16 further comprising the following steps:
(e) receiving data outputted in step (d) at the receiver; and
(f) exclusive-oring the data received in step (e) with the identity code stored in step (b).

22. The data processing method of claim 21 further comprising determining whether the receiver and the transmitter can synchronize based on the data received in step (e) after performing step (f).
